(19) United States
(12) Patent Application Publication
(10) Pub. No.: US 2017/0057170 A1
(43) Pub. Date: Mar. 2, 2017

(54) FACILITATING INTELLIGENT CALIBRATION AND EFFICEINT PERFORMANCE OF THREE-DIMENSIONAL PRINTERS

(71) Applicant: INTEL IP CORPORATION, Santa Clara, CA (US)

(72) Inventors: Lalit Gupta, Bangalore (IN); Shidlingeshwar Khatakalle, Gadhinglaj (IN)

(73) Assignee: INTEL IP CORPORATION, Santa Clara, CA (US)

(21) Appl. No.: 14/839,412

(22) Filed: Aug. 28, 2015

(51) Int. Cl. B29C 67/00

(52) U.S. Cl. CPC B29C 67/0088; B33Y 10/00

(57) ABSTRACT

A mechanism is described for facilitating intelligent calibration and efficient performance of three-dimensional printers according to one embodiment. A method of embodiments, as described herein, includes receiving a printing request for three-dimensional (3D) printing of a 3D object, and monitoring a printing process to print the 3D object, where the printing process is performed based on a reference design associated with the 3D object, the reference design including expected measurements associated with the 3D object. The method may further include computing, in real-time during the printing process, actual measurements relating to the 3D object, where the actual measurements are obtained via one or more 3D cameras. The method may further include comparing, in real-time, the actual measurements with the expected measurements to determine one or more measurement deficiencies caused by one or more errors encountered during the printing process, wherein, if the one or more errors are encountered, the one or more errors are compensated to facilitate the printing process to print the 3D object, and wherein, if no errors are encountered, the printing process continues to print the 3D object.

### FIELD

Embodiments described herein generally relate to computers. More particularly, embodiments relate to facilitating intelligent calibration and efficient performance of three-dimensional (3D) printers.

### BACKGROUND

Conventional techniques require manual calibration of 3D printers, which is cumbersome and prone to human error. Further, such conventional techniques are not capable of detecting or correcting any errors committed during print jobs at 3D printers.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a 3D printer qualification and performance mechanism according to one embodiment.

FIG. 2A illustrates a 3D printer qualification and performance mechanism according to one embodiment.

FIG. 2B illustrates an architectural placement according to one embodiment.

FIG. 3 illustrates a use case scenario according to one embodiment.

FIG. 4A illustrates a method for facilitating an automated pre-printing calibration process for determining 3D printing qualifications of a 3D printer according to one embodiment.

FIG. 4B illustrates a method for facilitating real-time intelligent monitoring of 3D printing at a 3D printer according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a technique for facilitating pre-printing calibration of 3D printing devices (“3D printers” or simply “printers”) to determine their qualification for performing printing tasks. Embodiments are further provided for real-time monitoring of the printing tasks, using one or more 3D cameras (e.g., Intel® RealSense®, etc.), such that any errors encountered during the performance of printing tasks are detected, identified, and resolved, in real-time, to avoid any waste of resources, such as time, power, material, etc.

Embodiments provide for using 3D cameras during calibration and 3D printing processes to obtain actual measurements relating to a 3D test object and a 3D real object, respectively, that are then compared with their corresponding expected measurements to determine any errors. Any deviation between one of the expected measurements and its corresponding actual measurement may be regarded as an error. Upon detecting an error, in one embodiment, a feedback message may be provided to, for example, 3D printing software at the 3D printer that is communicatively part of a network (e.g., Internet, Cloud, Internet of Things (IoT), proximity network, etc.) so that appropriate corrections may be made using the 3D printing software, tools, service providers, etc.

For example and in one embodiment, a feedback technique is provided to allow 3D printing software, as executed by a processor (e.g., Intel® Edison™, etc.) of a 3D printer, to know, in real-time, of the level of quality of a print job along with any errors that might occur during the performance of the print job. Conventional techniques are severely limited in that they require manual calibration of 3D printers, where a process of manually calibrating a 3D printer is complex, inefficient, and error-prone, while remaining unaware of any post-calibration errors (e.g., mechanical errors) that typically occur during the printing process, leading to inaccuracies in final printed objects and in some cases, a complete failure.

It is contemplated that a 3D printer uses a number of mechanism components of various types that are known for their non-deterministic behaviors due to, for example, certain environmental reasons, such as pressure, temperature, wear-and-tear, etc. For example, certain mechanical phenomena or errors, such jumping carriage of screws, thermal expansion, etc., typically occur due to continuous and long use of the housed mechanical components and are not known to occur during calibration.

Conventional techniques do not provide for a way to encounter and fix such errors nor do these conventional techniques offer feedback messaging to provide any information relating to such errors. Further, the conventional manner of performing calibration is inherently flawed for its manual nature.

It is contemplated and to be noted that embodiments are not limited to any particular number or type of 3D printers, printing or other software, printing objects or their materials, 3D cameras, computing devices, processers, and/or the like; however, for brevity, clarity, and ease of understanding, certain references are made throughout this document for exemplary purposes, but that embodiments are not to be construed to be limited as such.

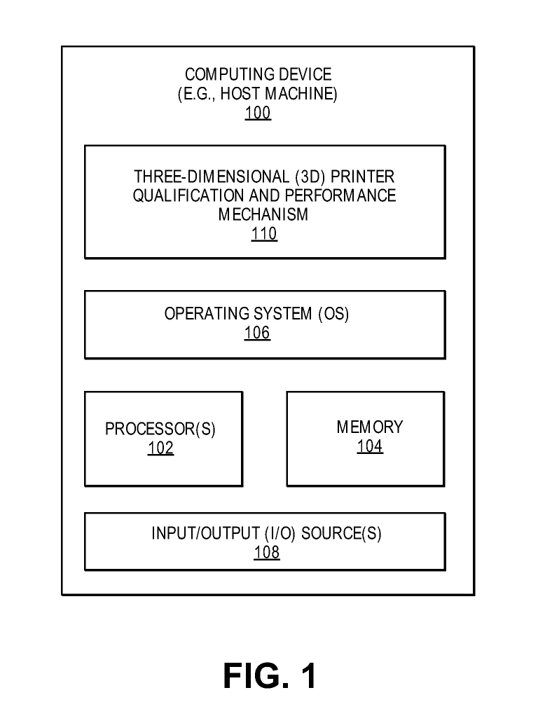

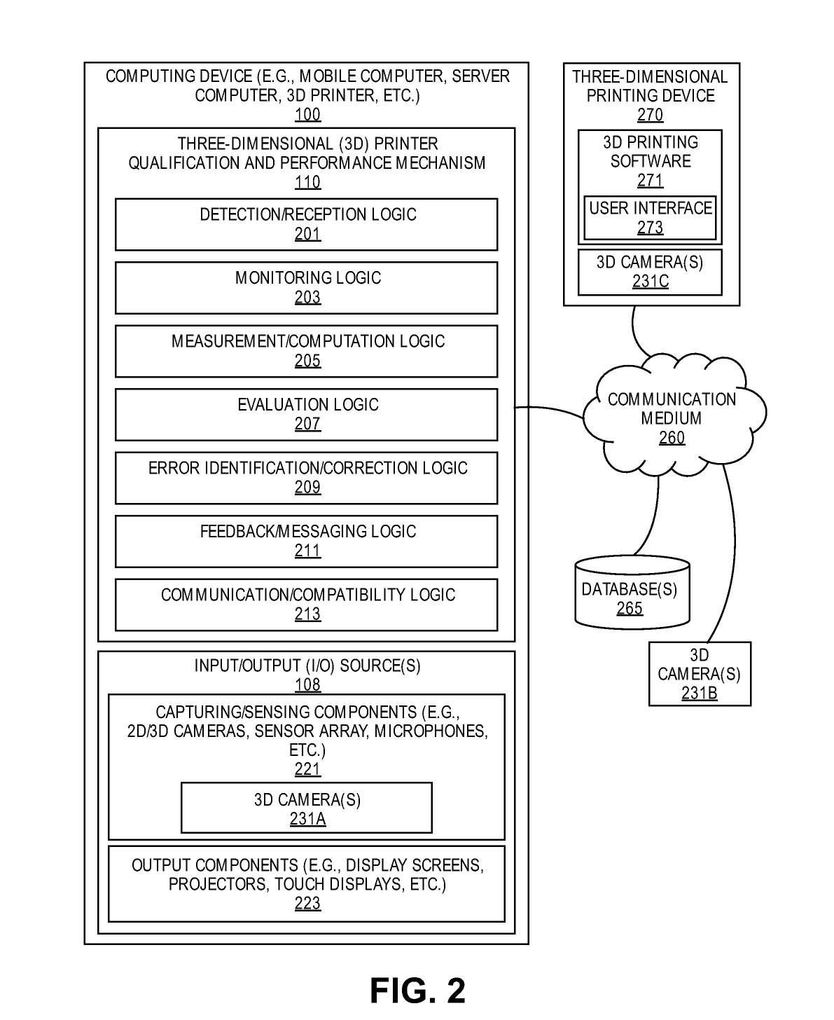

FIG. 1 illustrates a computing device 100 employing a 3D printer qualification and performance mechanism 110 according to one embodiment. Computing device 100 serves as a host machine for hosting 3D printer qualification and performance mechanism (“printer mechanism”) 110 that includes any number and type of components, as illustrated in FIG. 2, to facilitate real-time and dynamic qualification and performance of 3D printer as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, such as Google® Glass™, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a 3D printer qualification and performance mechanism 110 according to one embodiment. In one embodiment, printer mechanism 110 may include any number and type of components, such as (without limitation): detection/reception logic 201; monitoring logic 203; measurement/computation logic 205; evaluation logic 207; error identification/correction logic 209; feedback/messaging logic 211; and communication/compatibility logic 213.

In one embodiment, printer mechanism 110 may be hosted by computing device 100, such as a server computer, a desktop computer, a mobile computer (e.g., smartphone, tablet computer, etc.), wearable computer (e.g., wearable glasses, bracelet, etc.), etc. In another embodiment, printer mechanism 110 may be hosted at 3D printer 270, where printer mechanism 270 may be installed independently or as part of 3D printing software 271 at 3D printer 270. In yet another embodiment, printer mechanism 110 may be hosted at both computing device 100 and 3D printer 270, such as any number and type of components of printer mechanism 110 may be hosted at computing device 100 and any number and type of components of printer mechanism 110 may be hosted at 3D printer 270. In some embodiments, 3D printing software 271 may be hosted by computing device 100. Stated differently, embodiments are not limited to any particular implementation of printer mechanism 110; however, for the sake of brevity, clarity, and ease of understanding, printer mechanism 110 is shown at computing device 100 while 3D printing software 271 is shown at 3D printer 270.

Computing device 100 may include input/out sources 108 including capturing/sensing components 221 and output components 223 which, as will be further described below, may also include any number and type of components, sensor arrays, etc. For example, capturing/sensing components 221 may include cameras (e.g., two-dimensional (2D) cameras, 3D cameras, etc.), sensors array, etc. Similarly, output components 223 may include display screens, display/projection areas, projectors, etc.

For example and in one embodiment, capturing/sensing components 221 may include one or more 3D cameras, such as 3D camera(s) 231A (e.g., Intel® RealSense™ 3D camera). In another embodiment, one or more 3D cameras, such as 3D camera(s) 231B, may be hosted by 3D printer 270 and, in yet another embodiment, one or more 3D cameras, such as 3D camera(s 231C, may be employed elsewhere, such as mounted on a wall, placed on a table, held in a hand, etc. It is to be noted that embodiments are not limited to any number or placement of 3D cameras, such as any one or more of 3D cameras 231A, 231B and 231C may be employed or used. For example, computing device 100 may be locally placed within a close physical proximity of 3D printer 270 and thus, 3D camera 231A may be used. In some embodiments, 3D printer 270 may have one or more of its own 3D cameras, such as 3D camera 231B, to be used to perform various tasks, as will be further described in this document. In some embodiments, one or more cameras, such as 3D camera 231C, may be mounted on a wall or placed on a table to observe the printing tasks at 3D printer 270. Similarly, 3D cameras 231A-C are not limited to any particular type, such as Intel® RealSense™.

Computing device 100 may be further in communication with any number and type of other devices, such as 3D printer 270, over communication medium 260, such as one or more networks, where 3D printer 270 may be accessed by their corresponding users using one or more user interfaces, such as user interface 273 serving as an input/output console. Similarly, computing device 100 may be in communication, over communication medium 260, with any number and type of 3D cameras, such as 3D camera 231B, one or more additional computing devices, and one or more additional 3D printers, etc.

A 3D camera, such as 3D cameras 231A-C, may include depth-sensing technology to allow for observation of objects, humans, environment, etc., in virtually the same manner as human eyes are known to observe, while having the ability to add another dimension, such as a third dimension, to its observation, offer 3D scanning capabilities, measure simple and complex distances between points, recognize and interpret gestures, and/or the like.

A 3D printer, such as 3D printer 270, may be capable of producing or additively manufacturing 3D objects, such as by using additive processes where successive layers or slices are used to be laid down under software control. It is contemplated that the 3D objects may be of any type, size, shape, geometry, material, etc., that may be capable of being produced from a real-life 3D object or a software-produced electronic object. It is contemplated that any number and type of production processes, such as fused deposition modeling (FDM), light-activated production, etc., may be used by 3D printer 270 to produce 3D objects and that embodiments are limited to any particular type of process; however, for brevity, clarity, and ease of understanding, FDM may be referenced as an example throughout this document. For example, to produce a 3D object using FDM, any necessary amount and type of material (e.g., plastic, iron, steel, wood, etc.) may be fed into a reservoir of 3D printer 270, where, upon starting the printing/production process, a nozzle at 3D printer 270 may then begin to eject molten material which is then deposited, as molded part of the 3D object, on a platform (e.g., table, bed, etc.) which may itself be moveable. The nozzle itself or, in case of a moveable platform, a combination of the nozzle and the platform may be capable of moving in three directions, such as x-y-z directions.

For brevity, throughout the rest of this document, “3D camera” may be interchangeably referred to as “camera”, while “3D printer” may be interchangeably referred to as “printer”. Further, terms like “printing”, “producing”, “making”, and “manufacturing” may be used interchangeably throughout this document.

Computing device 100 may be further in communication with one or more repositories or data sources or databases, such as database 265, to obtain, communicate, store, and maintain any amount and type of data (e.g., media, metadata, templates, expected measurements of an object, actual measurements of an object as obtained through one or more of 3D cameras 231A-231C, real-time data, historical contents, user and/or device identification tags and other information, resources, policies, criteria, rules, regulations, upgrades, etc.).

In some embodiments, communication medium 260 may include any number and type of communication channels or networks, such as Cloud network, the Internet, intranet, Internet of Things (“IoT”), proximity network, Bluetooth, etc. It is contemplated that embodiments are not limited to any particular number or type of computing devices, 3D cameras, 3D printers, media sources, databases, personal devices, networks, etc.

Computing device 100 may further include I/O sources 108 having any number and type of capturing/sensing components 221 (e.g., sensor array (such as context/context-aware sensors and environmental sensors, such as camera sensors, ambient light sensors, Red Green Blue (RGB) sensors, movement sensors, etc.), depth sensing cameras, 2D cameras, 3D cameras, image sources, audio/video/signal detectors, microphones, eye/gaze-tracking systems, head-tracking systems, etc.) and output components 223 (e.g., audio/video/signal sources, display planes, display panels, display screens/devices, projectors, display/projection areas, speakers, etc.).

Capturing/sensing components 221 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing components 221 may further include one or more of supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of context sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

Further, for example, capturing/sensing components 221 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 221 may further include voice recognition devices, photo recognition devices, facial and other body recognition components, voice-to-text conversion components, etc.

Computing device 100 may further include one or more output components 223 in communication with one or more capturing/sensing components 221 and one or more components of printer mechanism 110 for facilitating qualification and printing tasks relating to 3D printer 270. For example, output components 223 may include a display device to display expected measurements and/or actual measurements relating to an object along with other relevant information, such as slicing details relating to the object for setting printing parameters for the object, G-code serving as numerical version or assembly language of instructions for controlling the nozzle, other software/firmware, such as Marlin, etc.

Similarly, output components 223 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output components 223 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

In one embodiment, printer mechanism 110 uses one or more of cameras 231A-C for facilitating calibration of printer 370 and providing feedback to 3D printing software 271 being executed by one or more processors at printer 370 such that printer 370 is not only calibrated prior to printing an object and monitored during printing to detect any potential errors, such as printer-related mechanical errors, interference by foreign objects (e.g., dust particles), unexpected vibrations or movements, changing environmental conditions (e.g., temperature, pressure, etc.), etc., that can obstruct or even prematurely end the printing process.

In one embodiment, calibration process of 3D printer 270 may be performed prior to initiating printing by 3D printer 270, where, for example, calibration in 3D printing is introduced to counter any deviation occurring due to changing environmental conditions, such as changes in levels of temperature, pressure, lighting, etc. For example and in one embodiment, in calibration process, a test 3D object (such as a small 1 cm×1 cm×1 cm cube) (also referred to as simply “test object”) may be test-produced and measured to determine whether 3D printer 270 is qualified to print/produce actual products as desired by a user. It is contemplated that with regard to the test object, embodiments are not limited to a particular geographic shape (such as cube), any particular size (such as 1 cm×1 cm×1 cm), or any other factors (such as surface thickness, type and amount of material, etc.), and/or the like.

In one embodiment, the calibration process for 3D printer 270 may be initiated with detection/reception logic 201 receiving a calibration request that may be placed by a user at computing device 100 or directly at 3D printer 270 via user interface 270. In some embodiments, the calibration process may be automatically triggered upon detecting a user request to print a 3D object. Further, upon triggering the calibration process, detection/reception logic 201 may receive or access expected measurements of a test 3D object (e.g., 1×1×1 cube) for calibration process, where these expected measurements describing precise shape, formation, size, etc., of the test object may be accessed at database 265, detecting at computing device 100 or 3D printer 270, received directly from the user. For example, the expected measurements may include expected size, surface thickness, type and amount of material, etc., relating to the test object.

Upon triggering the calibration process, the test 3D object may be produced by 3D printer 270, such as through FDM printing process, by pouring the material from the nozzle onto a platform, where this printing process may be observed by one or more of 3D cameras 231A-C as facilitated by monitoring logic 203. For example and in one embodiment, monitoring logic 203 may trigger one or more of 3D cameras 231A-C may take images or pictures of the test object while it is being produced at 3D printer 270. Similarly, in one embodiment, measurement/computation logic 205 facilitates one or more 3D cameras 231A-C to compute or obtain actual measurements, such as one or more of distances between two or more points, surface thickness, amount and type of material being used, overall size, overall shape, etc., relating to the test object.

Once the actual measurements are obtained, in one embodiment, using evaluation logic 207, these actual measurements are then compared with the expected measurements to determine whether the test object being produced at 3D printer 270 matches its expectations. If the do not match, feedback/messaging logic 211 may issue an alert or a feedback message to the user via computing device 100 and/or user interface 273 at 3D printer 270, where the alert/message may indicate that the 3D printer 270 has failed to produce the expected version of the 3D object and thus, this 3D printer 270 is not qualified to perform real printing of a real 3D object. It is contemplated that the user may choose to ignore 3D printer 270 or have it fixed to get it qualified for printing purposes. For example, fixing may include iteration of a process for adjusting various parameters or components of 3D printer 270 and/or expected measurements of the test object until qualification of 3D printer 270 is achieved, such as accommodating environmental variations, atmospheric changes, etc.

If, however, the test object is produced in accordance with the expectations, such as if the actual measurements match the expected measurements, feedback/message logic 211 may then generate a feedback message indicating an approval of 3D printer 270 as being calibrated, qualified, and ready for real printing, where the message may be communicated to the user via computing device 100 or user interface 273 of 3D printer 270.

Once the calibration process is completed and 3D printer 270 is determined to be qualified for real print jobs, the user may then choose to request a print job involving printing a 3D object, such as a dentist printing a human tooth, an archeologist printing an ancient skull, an auto engineer printing a model car, a child printing a toy, etc. It is contemplated that 3D printer 270 may be capable of printing any number and type of 3D objects and that embodiments are not limited to a particular number, size, type, etc., of a 3D object.

In one embodiment, once 3D printer 270 is calibrated and qualified to perform printing tasks, a request for printing a 3D object may be initiated and processed to produce the 3D object by 3D printer 270. It is contemplated that the print request may be placed by the user via computing device 100, 3D printer 270, etc., prior to, during, or upon complement of the calibration process, where the print request is detected by or received at detection/reception logic 201. Although this 3D object (e.g., tooth, car, toy, etc.) may be a real 3D object, any information (e.g., images, expected measurements, G-code, slicing criteria/pattern, printing protocols, etc.) about the 3D object may be obtained from one or more sources, such as database 265, computing device 100, 3D printer 270, directly from the user inputting the information at computing device and/or 3D printer 270, etc.

As with the calibration process, one the print request and any relevant information (e.g., images, expected measurements, G-code, slicing criteria/pattern, printing protocols, etc.) relating to the 3D object is received or accessed, the printing process for producing the 3D object may be initiated at 3D printer 270 as facilitated by monitoring logic 203. In one embodiment, upon initiating the printing process, monitoring logic 203 may then be triggered to monitor the entire process, including involving one or more 3D cameras 231A-C in one or more monitoring tasks relating to the printing process, such as taking video, pictures, images, etc., of the printing process.

In one embodiment, one or more 3D cameras 231A-C are further triggered by measurement/computation logic 205 to perform one or more computational tasks to help obtain actual measurements relating to producing of the 3D object at 3D printer 270, as previously described with respect to producing of the test object during the calibration process. For example, various components and/or functionalities of one or more 3D cameras 231A-C may be used to compute actual measurements, such as (without limitations) distances between two or more points, surface thickness, amount and type of material being used, overall size, overall shape, etc., relating to the 3D object being produced at 3D printer 270.

In one embodiment, evaluation logic 207 may be triggered to compare, in real-time, the expected measurements with the actual measurements as obtained by one or more 3D cameras 231A-C and as facilitated by measurement/computation logic 205. This real-time comparison of the expected and actual measurements may be performed to match expected measurement (e.g., size, shape, form, quality, thickness, material type, material amount, etc., of the 3D object) with its corresponding actual measurement to continuously determine, in real-time, any errors, flaws, deficiencies, interruptions, failures, etc., relating to printing of the 3D object at 3D printer 270.

If no errors, etc., are determined by error identification/correction logic 209, such as if the expected measurements are sufficiently matched with the actual measurements, the printing process may continue uninterrupted and 3D printer 270 may continue to produce the 3D object. In contrast, if an error is determined by error identification/correction logic 209, such as if any one of the expected measurements deviates from or is not sufficiently matched with its corresponding actual measurements, identification/correction logic 209 may then identify the actual error and, for correction purposes, forwards the error along with any relevant information to feedback/messaging logic 211 to that an appropriate and timely feedback/message may be generated and communicated back to the user at computing device 100 and/or user interface 273 of 3D printing software 271 at 3D printer 270.

It is contemplated that certain errors may be regarded as minor and/or simple, while certain other errors may be regarded as major and/or complex. In case of a minor error, such as a minor change to the overall printing parameters, a small adjustment to the room temperature, a quick removal of a dust particle, a trivial movement of the platform, etc., upon receiving the error message (e.g., error alert, error code, feedback message, detailed instructions, etc.) from feedback/messaging logic 211, the user may use one or more tools and/or trigger relevant software (e.g., 3D printing software 271 at 3D printer 270, control/administrative software at computing device 100, etc.), etc., to correct the error so that the printing process may continue without any further interruptions.

If, however, the error is regarded as a major or complex error (e.g., mechanical error, electronic error, system error, software error, jumping carriage of screws, thermal expansion, environmental changes, temperature fluctuation, etc.) that cannot be immediately corrected, other more significant steps may be taken to correct the error. In other words, in one embodiment, in case of a major error that threatens the entire printing process and can potentially waste a great deal of resources, such as time, power, material, etc., without producing an acceptable final product, identification/correction logic 209 forwards any information relating to this error to feedback/messaging logic 211 so that an appropriate and timely feedback is generated and communicated to the user ensure that the flawed process may be terminated or other appropriate measures may be taken to pause or end the printing process without any or further wastage of resources.

For example, in case of a software error, the 3D printing software 271 at 3D printer 270 or any control software at computing device 100 may be triggered to adjust the necessary internal parameters to compensate for the error such that any subsequent stages of 3D printing of the 3D object at 3D printer 270 are able to recover from the error and may continue to be performed without any interruptions relating to this error. Similarly, any mechanical or other such errors that are not typically expected during the calibration process, but may be detected during the process, are also encountered and corrected, such as using one or more tools, service providers, etc., upon receiving the relevant feedback message which, in turn, ensures increased accuracy, fluency, and efficiency in 3D printing.

Moreover, in one embodiment, communication/compatibility logic 211 may include various components relating to communication, messaging, compatibility, etc., such as connectivity and messaging logic, to facilitate communication and exchange of data or messages, such as feedback messages, error alerts, etc.

Communication/compatibility logic 211 may be used to facilitate dynamic communication and compatibility between computing device 100, 3D printer 270, 3D camera(s) 231B, database(s) 265, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, the Internet, Internet of Things, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “three-dimensional”, “3D”, “3D camera”, “3D printer”, “3D printing”, “3D producing”, “3D making”, “3D object”, “feedback”, “error messaging”, “smart device”, “mobile computer”, “wearable device”, etc., should not be read to limit embodiments to software or devices that carry that label in products or in literature external to this document.

It is contemplated that any number and type of components may be added to and/or removed from printer mechanism 110 to facilitate various embodiments including adding, removing, and/or enhancing certain features. For brevity, clarity, and ease of understanding of printer mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

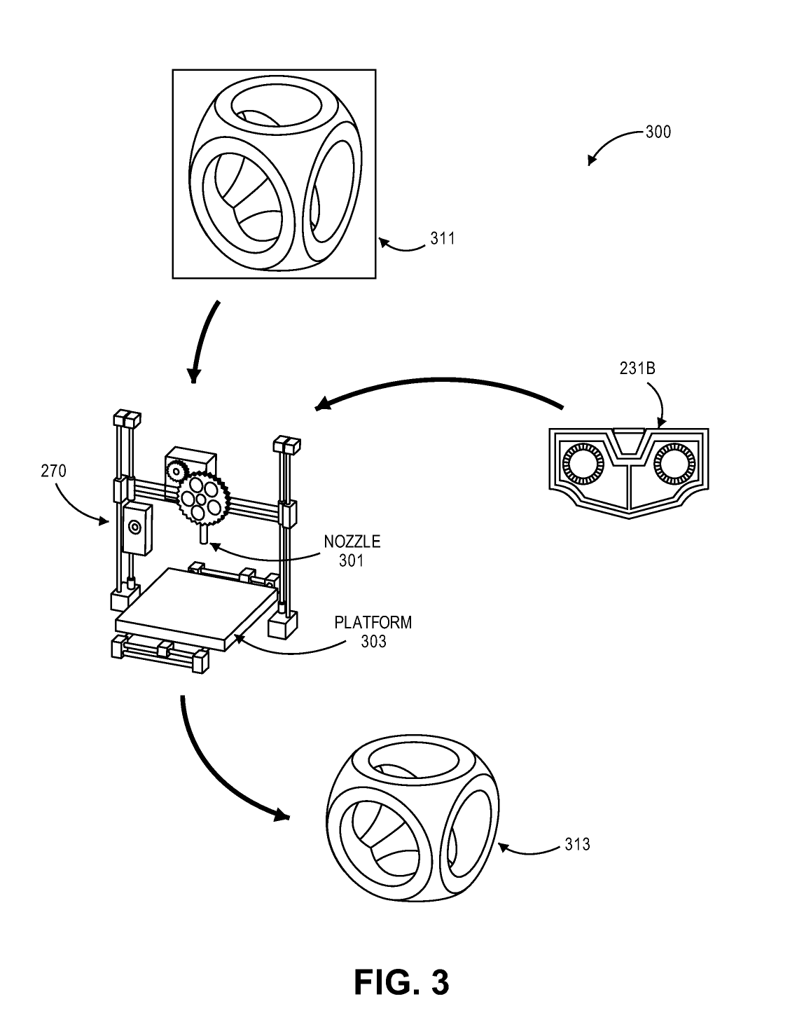

FIG. 3 illustrates a use case scenario 300 according to one embodiment. As an initial matter, for brevity, clarity, and ease of understanding, many of the components and processes discussed above with reference to FIGS. 1-2 may not be repeated or discussed hereafter. It is contemplated and to be noted that embodiments are not limited to any particular use case scenario, architectural setup, transaction sequence, etc., and that any number and type of components may be employed, placed, and used in any manner or form to perform the relevant tasks for facilitating calibration and 3D printing at 3D printers.

Referring to the illustrated embodiment, a reference design, such as reference design 311, of a real 3D object is obtained through software processing and provided as an input to 3D printer 270 to print/produce a corresponding 3D object, such as 3D object 313. In one embodiment, one or more 3D cameras, such as 3D camera 231B (e.g., Intel® RealSense™), is employed to perform a visual inspection 3D printer 270 and the printing process at 3D printer 270 to print 3D object 313 based on 3D object reference design 311. As previously discussed with reference to FIG. 2, 3D printer 270 may include nozzle 301 to dispense material on platform 303, wherein the material is received at platform 303 in a specified quantity and over a predetermined period of time to produce 3D object 313.

In one embodiment, as aforementioned with respect to FIG. 2, 3D camera 231B may be employed, such as placed on a table, mounted on a wall, etc., to be used to conduct visual monitoring of the printing process at 3D printer, where the visual monitoring includes computing or obtaining actual measurements relating to printing of 3D object 313. These actual measurements are then used for comparison with their corresponding expected measurements to determine whether there are any errors, flaws, interruptions, etc., encountered during the printing process or with regarding to 3D object 313 while being printed. For example and in one embodiment, since nozzle 301 and/or platform 303 are capable of moving in multiple dimensions, such as by x, y, z dimensions, 3D camera 231B may also counter the moves with its own x, y, z dimensional moves and continue to provide its findings to printer mechanism 110 of FIG. 2, over a network (e.g., IoT), to perform the comparison and any other evaluations.

If an error is detected, a feedback message is generated regarding the error and communicated to 3D printing software at 3D printer 270 and/or to printer mechanism 110 of FIG. 2 that is in communication with 3D printer 270. Upon receiving the feedback message, the error (e.g., mechanical error, software error, etc.) is corrected and the printing process is put back on track without or minimal loss of any resources. If, however, no errors are detected, the printing process continues without interruptions or delays and 3D printer 270 prints 3D object 313 based on 3D object reference design 311.

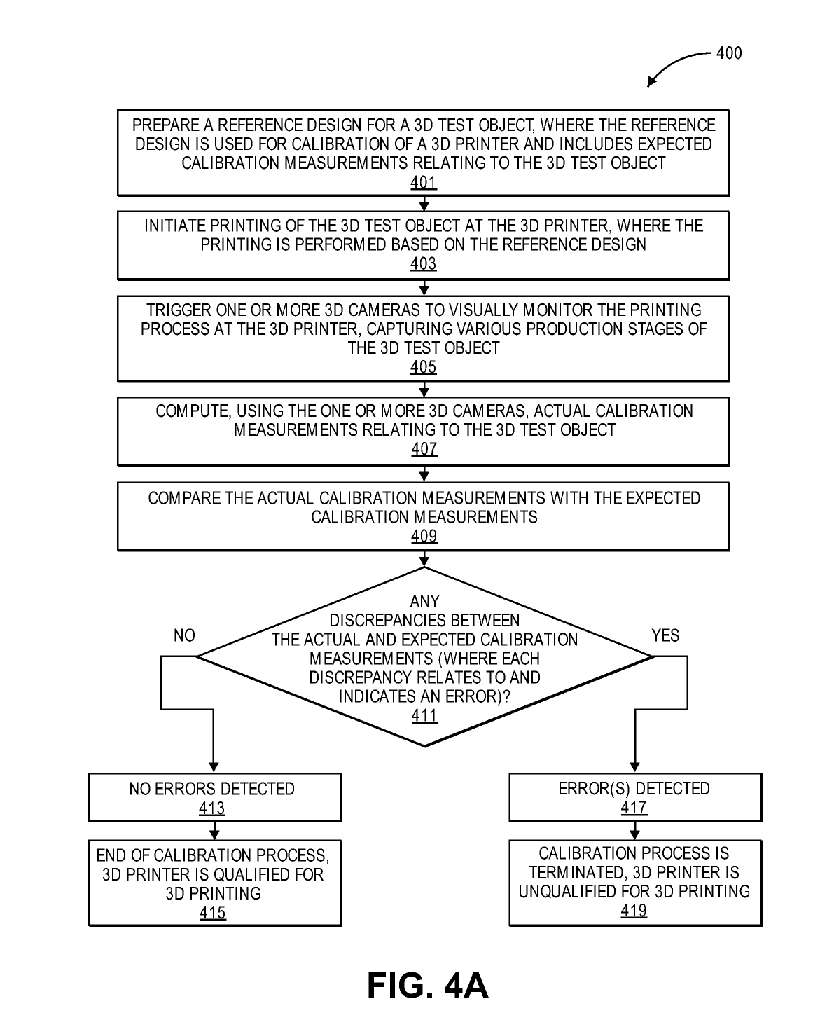

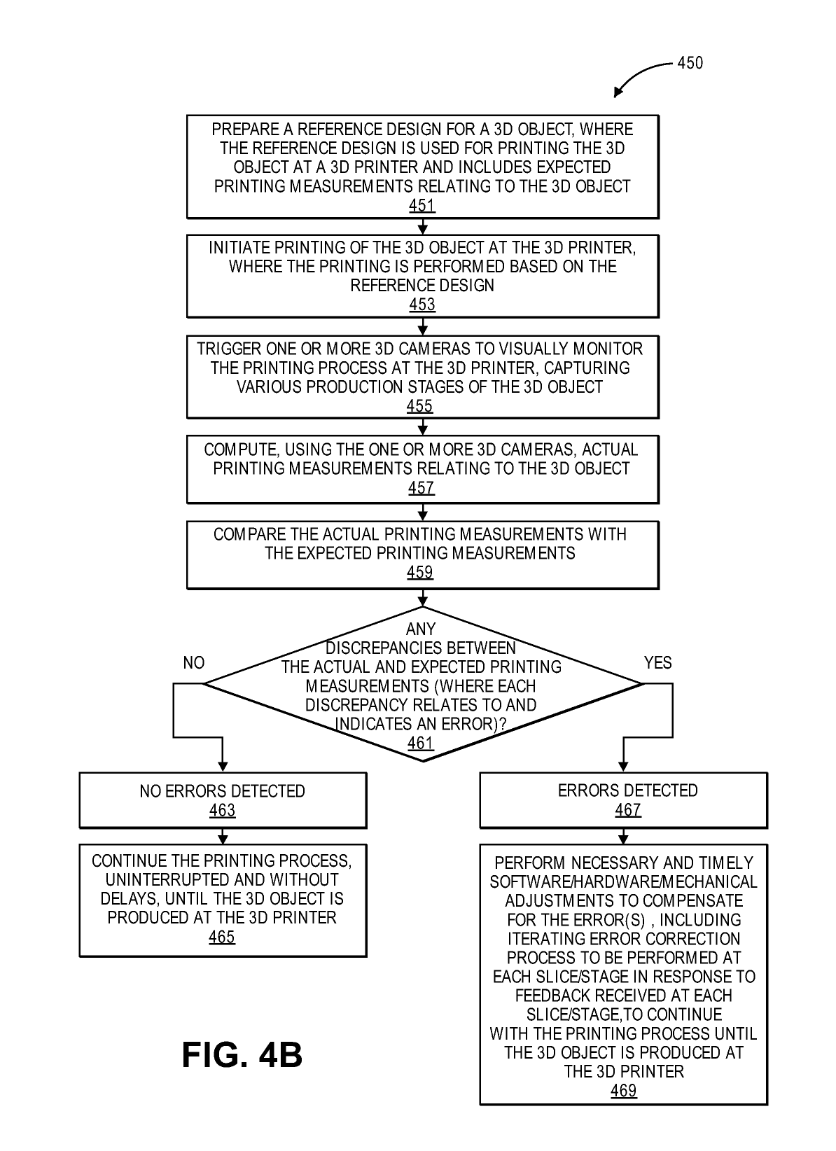

FIG. 4A illustrates a method 400 for facilitating an automated pre-printing calibration process for determining 3D printing qualifications of a 3D printer according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by printer mechanism 110 of FIG. 2. The processes of method 400 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 400 begins at 401 with preparing a reference design for a 3D test object to be used for calibration of the 3D printer to determine whether the 3D printer is qualified for performing 3D printing of real 3D objects. In one embodiment, the 3D test object may be a sample object of any shape, design, size, etc., such as a small 1 cm×1 cm×1 cm cube, a small triangle, a small circle, or any other geographic shape. Further, for example, the reference design for the 3D test object may be obtained using a 3D printing or design software at a computing device or the 3D printer, where the reference design may include expected values or measurements in x-y-z dimensions relating to the 3D test object.

At 403, the 3D printer is triggered to print the 3D test object based on its reference design. At 405, in one embodiment, as described with reference to FIG. 2, one or more 3D cameras at one or more locations (such as at the 3D printer, one or more computing devices (e.g., mobile computers), installed on one or more walls, placed at one or more tables, etc.) may be used to perform real-time visual monitoring of the printing of the 3D test object. At 407, in one embodiment, the one or more 3D cameras are further triggered to use one or more of their components, techniques, etc., to perform computations to obtain actual values or measurements relating to the 3D test object and its printing process for calibration purposes.

At 409, in one embodiment, as described with reference to FIG. 2, the actual measurements are compared with the expected measurements. At 411, a determination is made as to whether there are any discrepancies between the actual and expected measurements, such as whether one or more actual values obtained through the one or more 3D cameras deviate from or do not match with their corresponding one or more expected values obtained from the reference design. In one embodiment, any deviation may be regarded as an error (e.g., mechanical error, software error, etc.) caused by any number and type of factors, mechanical breakdown, software bug, atmospheric changes, temperature variations, dust particles, bulges, air pockets, and/or the like. At 413, if no deviation in the comparison is not detected, then no errors are determined to be found and, in one embodiment, at 415, the printing process ends and the 3D printer is regarded as calibrated and qualified for printing a real 3D object as will be further described with reference to FIG. 4B.

At 417, if, however, a deviation in the comparison is detected, it is regarded as being due to an error. In case of the error, at 419, in one embodiment, the 3D printer is regarded as unqualified to be used for 3D printing purposes (until and unless, in one embodiment, the error is corrected or compensated and the 3D printer is successfully re-calibrated). However, in some embodiments, necessary changes or adjustments may be made to compensate for the error for re-calibration of the 3D printer at a later point in time. For example, in case of a software error, various printing parameters at the 3D printing software of the 3D printer may be modified to compensate for the error. Similarly, for example, in case of a mechanical error, one or more components or parts of the 3D printer or another relevant device may be tuned or replaced to overcome the mechanical error, such as fixing or replacing the nozzle, removing the dust particle, lowering or increasing room temperature by adjusting a thermostat, manually removing a dust particle, changing the amount or type of material being used for printing, etc.

FIG. 4B illustrates a method 450 for facilitating real-time intelligent monitoring of 3D printing at a 3D printer according to one embodiment. Method 450 may be performed by processing logic that may comprise hardware (e.g., circuitry, dedicated logic, programmable logic, etc.), software (such as instructions run on a processing device), or a combination thereof. In one embodiment, method 450 may be performed by printer mechanism 110 of FIG. 2. The processes of method 450 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 450 begins at 451 with preparing a reference design for a 3D object to be printed at the 3D printer. In one embodiment, the 3D object may include an object of any type, shape, design, form, material, size, etc., such as ranging from a child's toy to an archeological skull to a military tank, and/or the like. Further, for example and in one embodiment, the reference design for the 3D object may be put together using a 3D printing/design software at a computing device and/or the 3D printer, where the reference design may include expected values or measurements in x-y-z dimensions relating to the 3D object.

At 453, the 3D printer is triggered to print the 3D object based on its reference design. At 455, in one embodiment, as described with reference to FIG. 2, one or more 3D cameras at one or more locations (such as at the 3D printer, one or more computing devices (e.g., mobile computers), installed on one or more walls, placed at one or more tables, etc.) may be used to perform real-time visual monitoring of the printing of the 3D object. At 457, in one embodiment, the one or more 3D cameras are further triggered to use one or more of their components, techniques, etc., to perform computations to obtain actual values or measurements relating to the 3D object and the process for printing the 3D object.

At 459, in one embodiment, as described with reference to FIG. 2, the actual measurements are compared with the expected measurements. At 461, a determination is made as to whether there are any discrepancies between the actual and expected measurements, such as whether one or more actual values obtained through the one or more 3D cameras deviate from or do not match with their corresponding one or more expected values obtained from the reference design. In one embodiment, any deviation may be regarded as an error (e.g., mechanical error, software error, etc.) caused by any number and type of factors, mechanical breakdown, software bug, atmospheric changes, temperature variations, dust particles, bulges, air pockets, and/or the like. At 463, if no deviation in the comparison is not detected, then no errors are determined to be found and, in one embodiment, at 465, the printing process continues uninterrupted and without any delays and ends with the printing of the 3D object in accordance with its reference design.

At 467, if, however, a deviation in the comparison is detected, it is regarded as being due to an error (e.g., mechanical error, software error, etc.) caused by any number and type of factors, mechanical breakdown, software bug, atmospheric changes, temperature variations, dust particles, bulges, air pockets, and/or the like. In one embodiment, necessary and timely changes or adjustments may be made to compensate for the error to continue printing the 3D object without further interruptions or delays at 469. It is contemplated that not every error can be corrected with one attempt or adjustment and accordingly, in one embodiment, an error correction process may also include performing iterative process of correction of an error and thus the 3D printing processes, in various slices or stages, with continues feedback from one or more of the 3D cameras which may also be received at various slices or stages of the 3D printing process.

For example, as aforementioned, in case of a software error, various printing parameters at the 3D printing software of the 3D printer may be modified to compensate for the error. Similarly, for example, in case of a mechanical error, one or more components or parts of the 3D printer or another relevant device may be tuned or replaced to overcome the mechanical error, such as fixing or replacing the nozzle, removing the dust particle, lowering or increasing room temperature by adjusting a thermostat, manually removing a dust particle, changing the amount or type of material being used for printing, etc.

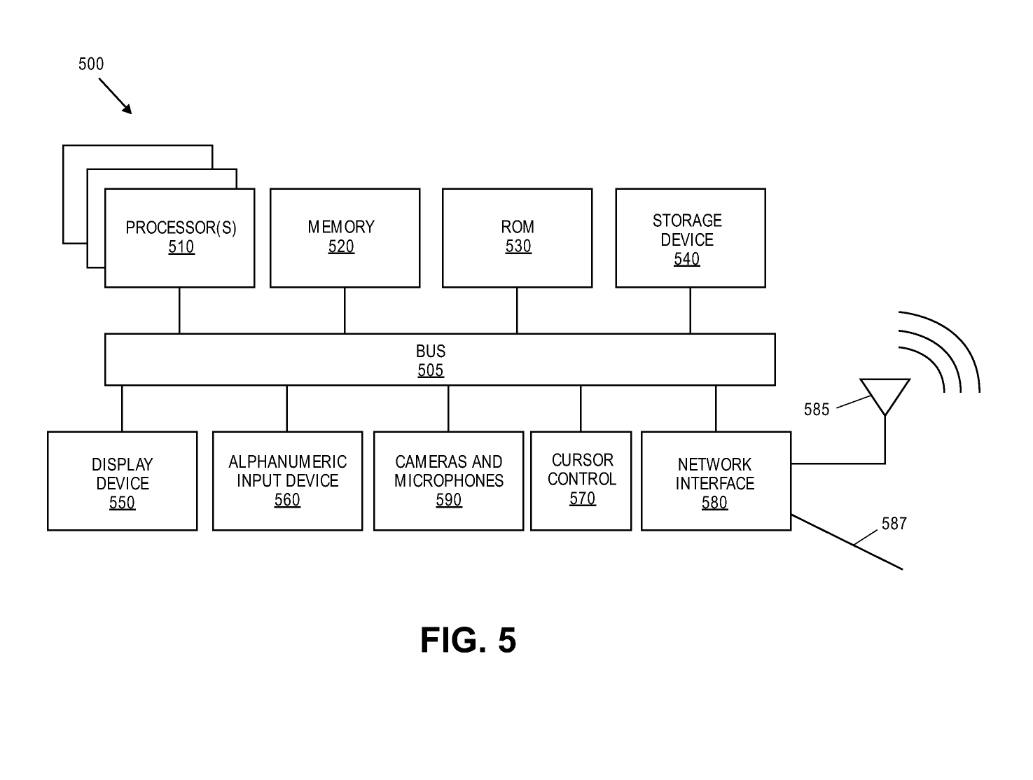

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

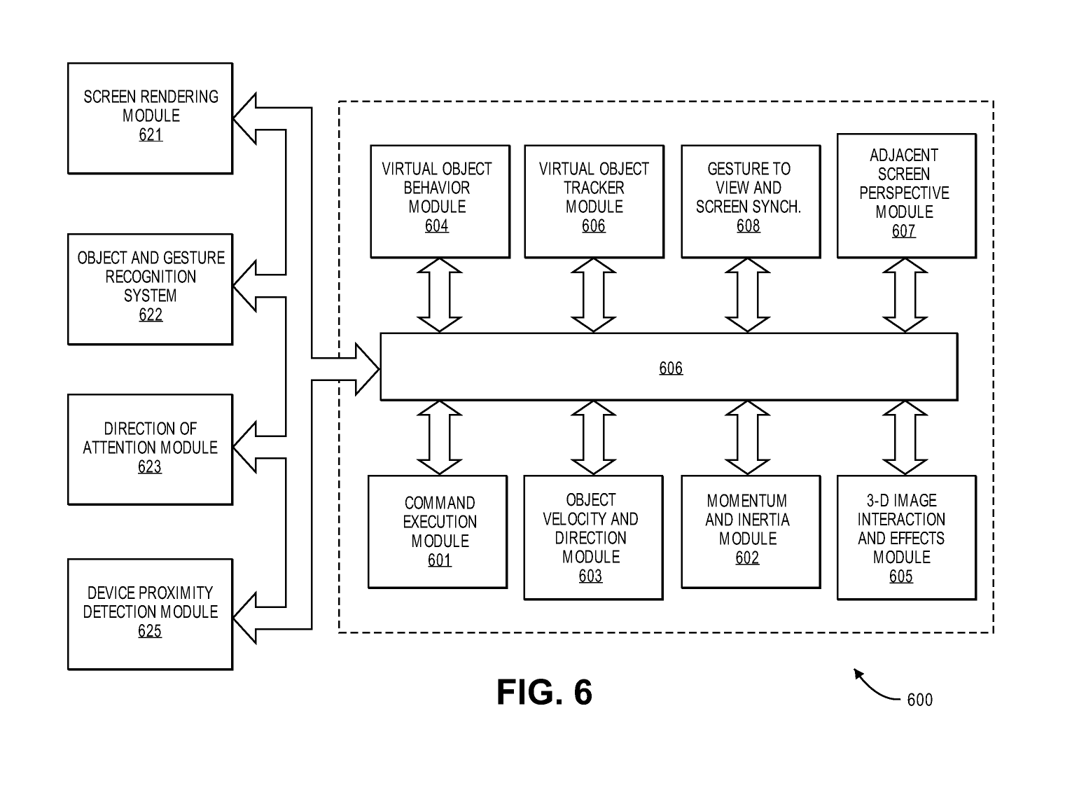

FIG. 6 illustrates an embodiment of a computing environment 600 capable of supporting the operations discussed above. The modules and systems can be implemented in a variety of different hardware architectures and form factors including that shown in FIG. 4.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in a three dimensional space in a vicinity of an display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate intelligent calibration and efficient performance of three-dimensional printers, comprising: detection/reception logic to receive a printing request for three-dimensional (3D) printing of a 3D object; monitoring logic to monitor a printing process to print the 3D object, wherein the printing process is performed based on a reference design associated with the 3D object, the reference design including expected measurements associated with the 3D object; measurement/computation logic to compute, in real-time during the printing process, actual measurements relating to the 3D object, wherein the actual measurements are obtained via one or more 3D cameras; and evaluation logic to compare, in real-time, the actual measurements with the expected measurements to determine one or more measurement deficiencies caused by one or more errors encountered during the printing process, wherein, if the one or more errors are encountered, the one or more errors are compensated to facilitate the printing process to print the 3D object, and wherein, if no errors are encountered, the printing process continues to print the 3D object.

Example 2 includes the subject matter of Example 1, wherein the monitoring logic is further to facilitate the one or more 3D cameras to perform visual monitoring of the printing process such that the 3D object is visually monitored at various stages of producing during the printing process, wherein the printing process to print the 3D object is performed at a 3D printer.

Example 3 includes the subject matter of Example 1, wherein the measurement/computation logic is further to trigger the one or more 3D cameras to facilitate the computation of the actual measurements, wherein the computation is performed using one or more components or features of the one or more 3D cameras.

Example 4 includes the subject matter of Example 1, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

Example 5 includes the subject matter of Example 1, further comprising: error identification/correction logic to detect the one or more errors; and feedback/messaging logic to generate a feedback message identifying the one or more errors, wherein the feedback message is further to provide information relating to the compensation of the one or more errors; and communication/compatibility logic to communicate the feedback message to one or more users via the one or more computing devices.

Example 6 includes the subject matter of Example 1, wherein the detection/reception logic is further to receive a calibration request to determine whether the 3D printer is qualified to perform the printing process.

Example 7 includes the subject matter of Example 6, wherein the monitoring logic is further to monitor a calibration process to print a test 3D object at the 3D printer, wherein the calibration process is performed prior to performing the printing process, wherein the calibration process is performed based on expected calibration measurements associated with the test 3D object.

Example 8 includes the subject matter of Example 7, wherein the measurement/computation logic is further to compute, in real-time, during the calibration process, actual calibration measurements relating to the test 3D object, wherein the actual calibration measurements are obtained via the one or more 3D cameras.

Example 9 includes the subject matter of Example 8, wherein the evaluation logic is further to compare, in real-time, the actual calibration measurements with the expected calibration measurements to determine one or more calibration deficiencies caused by one or more calibration errors encountered during the calibration process, wherein, if the one or more calibration errors are encountered, the calibration process is terminated and the 3D printer is regarded as unqualified to perform the printing process, and wherein, if no calibration errors are encountered, the calibration process is completed and the 3D printer is regarded as qualified to perform the printing process.

Some embodiments pertain to Example 10 that includes a method for facilitating intelligent calibration and efficient performance of three-dimensional printers, comprising: receiving a printing request for three-dimensional (3D) printing of a 3D object; monitoring a printing process to print the 3D object, wherein the printing process is performed based on a reference design associated with the 3D object, the reference design including expected measurements associated with the 3D object; computing, in real-time during the printing process, actual measurements relating to the 3D object, wherein the actual measurements are obtained via one or more 3D cameras; and comparing, in real-time, the actual measurements with the expected measurements to determine one or more measurement deficiencies caused by one or more errors encountered during the printing process, wherein, if the one or more errors are encountered, the one or more errors are compensated to facilitate the printing process to print the 3D object, and wherein, if no errors are encountered, the printing process continues to print the 3D object.

Example 11 includes the subject matter of Example 10, wherein monitoring further includes facilitating the one or more 3D cameras to perform visual monitoring of the printing process such that the 3D object is visually monitored at various stages of producing during the printing process, wherein the printing process to print the 3D object is performed at a 3D printer.

Example 12 includes the subject matter of Example 10, wherein computing further includes triggering the one or more 3D cameras to facilitate the computation of the actual measurements, wherein the computation is performed using one or more components or features of the one or more 3D cameras.

Example 13 includes the subject matter of Example 10, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

Example 14 includes the subject matter of Example 10, further comprising: detecting the one or more errors; and generating a feedback message identifying the one or more errors, wherein the feedback message is further to provide information relating to the compensation of the one or more errors; and communicating the feedback message to one or more users via the one or more computing devices.

Example 15 includes the subject matter of Example 10, wherein receiving further includes receiving a calibration request to determine whether the 3D printer is qualified to perform the printing process.

Example 16 includes the subject matter of Example 15, further comprising monitoring a calibration process to print a test 3D object at the 3D printer, wherein the calibration process is performed prior to performing the printing process, wherein the calibration process is performed based on expected calibration measurements associated with the test 3D object.

Example 17 includes the subject matter of Example 16, further comprising computing, in real-time, during the calibration process, actual calibration measurements relating to the test 3D object, wherein the actual calibration measurements are obtained via the one or more 3D cameras.

Example 18 includes the subject matter of Example 17, further comprising comparing, in real-time, the actual calibration measurements with the expected calibration measurements to determine one or more calibration deficiencies caused by one or more calibration errors encountered during the calibration process, wherein, if the one or more calibration errors are encountered, the calibration process is terminated and the 3D printer is regarded as unqualified to perform the printing process, and wherein, if no calibration errors are encountered, the calibration process is completed and the 3D printer is regarded as qualified to perform the printing process.

Some embodiments pertain to Example 19 includes a system comprising a storage device having instructions, and a processor to execute the instructions to facilitate a mechanism to perform one or more operations comprising: receiving a printing request for three-dimensional (3D) printing of a 3D object; monitoring a printing process to print the 3D object, wherein the printing process is performed based on a reference design associated with the 3D object, the reference design including expected measurements associated with the 3D object; computing, in real-time during the printing process, actual measurements relating to the 3D object, wherein the actual measurements are obtained via one or more 3D cameras; and comparing, in real-time, the actual measurements with the expected measurements to determine one or more measurement deficiencies caused by one or more errors encountered during the printing process, wherein, if the one or more errors are encountered, the one or more errors are compensated to facilitate the printing process to print the 3D object, and wherein, if no errors are encountered, the printing process continues to print the 3D object.

Example 20 includes the subject matter of Example 19, wherein monitoring further includes facilitating the one or more 3D cameras to perform visual monitoring of the printing process such that the 3D object is visually monitored at various stages of producing during the printing process, wherein the printing process to print the 3D object is performed at a 3D printer.

Example 21 includes the subject matter of Example 19, wherein computing further includes triggering the one or more 3D cameras to facilitate the computation of the actual measurements, wherein the computation is performed using one or more components or features of the one or more 3D cameras.

Example 22 includes the subject matter of Example 19, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

Example 23 includes the subject matter of Example 19, wherein the one or more operations further comprise: detecting the one or more errors; and generating a feedback message identifying the one or more errors, wherein the feedback message is further to provide information relating to the compensation of the one or more errors; and communicating the feedback message to one or more users via the one or more computing devices.

Example 24 includes the subject matter of Example 19, wherein receiving further includes receiving a calibration request to determine whether the 3D printer is qualified to perform the printing process.

Example 25 includes the subject matter of Example 24, wherein the one or more operations further comprise monitoring a calibration process to print a test 3D object at the 3D printer, wherein the calibration process is performed prior to performing the printing process, wherein the calibration process is performed based on expected calibration measurements associated with the test 3D object.

Example 26 includes the subject matter of Example 25, wherein the one or more operations further comprise computing, in real-time, during the calibration process, actual calibration measurements relating to the test 3D object, wherein the actual calibration measurements are obtained via the one or more 3D cameras.

Example 27 includes the subject matter of Example 26, wherein the one or more operations further comprise comparing, in real-time, the actual calibration measurements with the expected calibration measurements to determine one or more calibration deficiencies caused by one or more calibration errors encountered during the calibration process, wherein, if the one or more calibration errors are encountered, the calibration process is terminated and the 3D printer is regarded as unqualified to perform the printing process, and wherein, if no calibration errors are encountered, the calibration process is completed and the 3D printer is regarded as qualified to perform the printing process.

Some embodiments pertain to Example 28 includes an apparatus comprising: means for receiving a printing request for three-dimensional (3D) printing of a 3D object; means for monitoring a printing process to print the 3D object, wherein the printing process is performed based on a reference design associated with the 3D object, the reference design including expected measurements associated with the 3D object; means for computing, in real-time during the printing process, actual measurements relating to the 3D object, wherein the actual measurements are obtained via one or more 3D cameras; and means for comparing, in real-time, the actual measurements with the expected measurements to determine one or more measurement deficiencies caused by one or more errors encountered during the printing process, wherein, if the one or more errors are encountered, the one or more errors are compensated to facilitate the printing process to print the 3D object, and wherein, if no errors are encountered, the printing process continues to print the 3D object.

Example 29 includes the subject matter of Example 28, wherein the means for monitoring further includes means for facilitating the one or more 3D cameras to perform visual monitoring of the printing process such that the 3D object is visually monitored at various stages of producing during the printing process, wherein the printing process to print the 3D object is performed at a 3D printer.

Example 30 includes the subject matter of Example 28, wherein the means for computing further includes means for triggering the one or more 3D cameras to facilitate the computation of the actual measurements, wherein the computation is performed using one or more components or features of the one or more 3D cameras.

Example 31 includes the subject matter of Example 28, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

Example 32 includes the subject matter of Example 28, wherein the one or more operations further comprise: means for detecting the one or more errors; and generating a feedback message identifying the one or more errors, wherein the feedback message is further to provide information relating to the compensation of the one or more errors; and means for communicating the feedback message to one or more users via the one or more computing devices.

Example 33 includes the subject matter of Example 28, wherein the means for receiving further includes means for receiving a calibration request to determine whether the 3D printer is qualified to perform the printing process.

Example 34 includes the subject matter of Example 33, wherein the one or more operations further comprise means for monitoring a calibration process to print a test 3D object at the 3D printer, wherein the calibration process is performed prior to performing the printing process, wherein the calibration process is performed based on expected calibration measurements associated with the test 3D object.

Example 35 includes the subject matter of Example 34, wherein the one or more operations further comprise means for computing, in real-time, during the calibration process, actual calibration measurements relating to the test 3D object, wherein the actual calibration measurements are obtained via the one or more 3D cameras.

Example 36 includes the subject matter of Example 35, wherein the one or more operations further comprise means for comparing, in real-time, the actual calibration measurements with the expected calibration measurements to determine one or more calibration deficiencies caused by one or more calibration errors encountered during the calibration process, wherein, if the one or more calibration errors are encountered, the calibration process is terminated and the 3D printer is regarded as unqualified to perform the printing process, and wherein, if no calibration errors are encountered, the calibration process is completed and the 3D printer is regarded as qualified to perform the printing process.

Example 37 includes at least one machine-readable medium comprising a plurality of instructions, when executed on a computing device, to implement or perform a method as claimed in any of claims or examples 10-18.

Example 38 includes at least one non-transitory machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to receive a printing request for three-dimensional (3D) printing of a 3D object;
monitoring logic to monitor a printing process to print the 3D object, wherein the printing process is performed based on a reference design associated with the 3D object, the reference design including expected measurements associated with the 3D object;
measurement/computation logic to compute, in real-time during the printing process, actual measurements relating to the 3D object, wherein the actual measurements are obtained via one or more 3D cameras; and
evaluation logic to compare, in real-time, the actual measurements with the expected measurements to determine one or more measurement deficiencies caused by one or more errors encountered during the printing process,
wherein, if the one or more errors are encountered, the one or more errors are compensated to facilitate the printing process to print the 3D object, and
wherein, if no errors are encountered, the printing process continues to print the 3D object.

2. The apparatus of claim 1, wherein the monitoring logic is further to facilitate the one or more 3D cameras to perform visual monitoring of the printing process such that the 3D object is visually monitored at various stages of producing during the printing process, wherein the printing process to print the 3D object is performed at a 3D printer.

3. The apparatus of claim 1, wherein the measurement/computation logic is further to trigger the one or more 3D cameras to facilitate the computation of the actual measurements, wherein the computation is performed using one or more components or features of the one or more 3D cameras.

4. The apparatus of claim 1, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

5. The apparatus of claim 1, further comprising:
error identification/correction logic to detect the one or more errors; and
feedback/messaging logic to generate a feedback message identifying the one or more errors, wherein the feedback message is further to provide information relating to the compensation of the one or more errors; and
communication/compatibility logic to communicate the feedback message to one or more users via the one or more computing devices.

6. The apparatus of claim 1, wherein the detection/reception logic is further to receive a calibration request to determine whether the 3D printer is qualified to perform the printing process.

7. The apparatus of claim 6, wherein the monitoring logic is further to monitor a calibration process to print a test 3D object at the 3D printer, wherein the calibration process is performed prior to performing the printing process, wherein the calibration process is performed based on expected calibration measurements associated with the test 3D object.

8. The apparatus of claim 7, wherein the measurement/computation logic is further to compute, in real-time, during the calibration process, actual calibration measurements relating to the test 3D object, wherein the actual calibration measurements are obtained via the one or more 3D cameras.

9. The apparatus of claim 8, wherein the evaluation logic is further to compare, in real-time, the actual calibration measurements with the expected calibration measurements to determine one or more calibration deficiencies caused by one or more calibration errors encountered during the calibration process,
wherein, if the one or more calibration errors are encountered, the calibration process is terminated and the 3D printer is regarded as unqualified to perform the printing process, and
wherein, if no calibration errors are encountered, the calibration process is completed and the 3D printer is regarded as qualified to perform the printing process.

10. A method comprising:
receiving a printing request for three-dimensional (3D) printing of a 3D object;
monitoring a printing process to print the 3D object, wherein the printing process is performed based on a reference design associated with the 3D object, the reference design including expected measurements associated with the 3D object;
computing, in real-time during the printing process, actual measurements relating to the 3D object, wherein the actual measurements are obtained via one or more 3D cameras; and
comparing, in real-time, the actual measurements with the expected measurements to determine one or more measurement deficiencies caused by one or more errors encountered during the printing process,
wherein, if the one or more errors are encountered, the one or more errors are compensated to facilitate the printing process to print the 3D object, and
wherein, if no errors are encountered, the printing process continues to print the 3D object.

11. The method of claim 10, wherein monitoring further includes facilitating the one or more 3D cameras to perform visual monitoring of the printing process such that the 3D object is visually monitored at various stages of producing during the printing process, wherein the printing process to print the 3D object is performed at a 3D printer.

12. The method of claim 10, wherein computing further includes triggering the one or more 3D cameras to facilitate the computation of the actual measurements, wherein the computation is performed using one or more components or features of the one or more 3D cameras.

13. The method of claim 10, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

14. The method of claim 10, further comprising:
detecting the one or more errors; and
generating a feedback message identifying the one or more errors, wherein the feedback message is further to provide information relating to the compensation of the one or more errors; and
communicating the feedback message to one or more users via the one or more computing devices.

15. The method of claim 10, wherein receiving further includes receiving a calibration request to determine whether the 3D printer is qualified to perform the printing process.

16. The method of claim 15, further comprising monitoring a calibration process to print a test 3D object at the 3D printer, wherein the calibration process is performed prior to performing the printing process, wherein the calibration process is performed based on expected calibration measurements associated with the test 3D object.

17. The method of claim 16, further comprising computing, in real-time, during the calibration process, actual calibration measurements relating to the test 3D object, wherein the actual calibration measurements are obtained via the one or more 3D cameras.

18. The method of claim 17, further comprising comparing, in real-time, the actual calibration measurements with the expected calibration measurements to determine one or more calibration deficiencies caused by one or more calibration errors encountered during the calibration process,
wherein, if the one or more calibration errors are encountered, the calibration process is terminated and the 3D printer is regarded as unqualified to perform the printing process, and
wherein, if no calibration errors are encountered, the calibration process is completed and the 3D printer is regarded as qualified to perform the printing process.

19. At least one machine-readable medium comprising a plurality of instructions, executed on a computing device, to facilitate the computing device to perform one or more operations comprising:
receiving a printing request for three-dimensional (3D) printing of a 3D object;
monitoring a printing process to print the 3D object, wherein the printing process is performed based on a reference design associated with the 3D object, the reference design including expected measurements associated with the 3D object;
computing, in real-time during the printing process, actual measurements relating to the 3D object, wherein the actual measurements are obtained via one or more 3D cameras; and
comparing, in real-time, the actual measurements with the expected measurements to determine one or more measurement deficiencies caused by one or more errors encountered during the printing process,
wherein, if the one or more errors are encountered, the one or more errors are compensated to facilitate the printing process to print the 3D object, and
wherein, if no errors are encountered, the printing process continues to print the 3D object.

20. The machine-readable medium of claim 19, wherein monitoring further includes facilitating the one or more 3D cameras to perform visual monitoring of the printing process such that the 3D object is visually monitored at various stages of producing during the printing process, wherein the printing process to print the 3D object is performed at a 3D printer.

21. The machine-readable medium of claim 19, wherein computing further includes triggering the one or more 3D cameras to facilitate the computation of the actual measurements, wherein the computation is performed using one or more components or features of the one or more 3D cameras.

22. The machine-readable medium of claim 19, wherein the one or more 3D cameras are strategically placed such that the one or more 3D cameras have a continues view of at least one of a nozzle and a platform of the 3D printer, wherein the nozzle to dispense a material on the platform to form the 3D object on the platform, wherein the one or more 3D cameras are strategically placed by being at least of installed on the 3D platform, placed at one or more tables, mounted on one or more walls, and hosted by one or more computing devices in communication with the 3D platform.

23. The machine-readable medium of claim 19, further comprising:
detecting the one or more errors; and
generating a feedback message identifying the one or more errors, wherein the feedback message is further to provide information relating to the compensation of the one or more errors; and
communicating the feedback message to one or more users via the one or more computing devices.

24. The machine-readable medium of claim 19, wherein receiving further includes receiving a calibration request to determine whether the 3D printer is qualified to perform the printing process.

25. The machine-readable medium of claim 24, further comprising:
monitoring a calibration process to print a test 3D object at the 3D printer, wherein the calibration process is performed prior to performing the printing process, wherein the calibration process is performed based on expected calibration measurements associated with the test 3D object;
computing, in real-time, during the calibration process, actual calibration measurements relating to the test 3D object, wherein the actual calibration measurements are obtained via the one or more 3D cameras; and
comparing, in real-time, the actual calibration measurements with the expected calibration measurements to determine one or more calibration deficiencies caused by one or more calibration errors encountered during the calibration process,
wherein, if the one or more calibration errors are encountered, the calibration process is terminated and the 3D printer is regarded as unqualified to perform the printing process, and
wherein, if no calibration errors are encountered, the calibration process is completed and the 3D printer is regarded as qualified to perform the printing process.
